(19) United States
(12) Patent Application Publication
(10) Pub. No.: US 2025/0360664 A1
(43) Pub. Date: Nov. 27, 2025

(54) CO-INJECTION MOLDING APPARATUS

(71) Applicant: TOP GRADE MOLDS LTD., Mississauga (CA)

(72) Inventors: Vincenzo CICCONE, Kleinburg (CA); Hon Kee WU, Oakville (CA)

(21) Appl. No.: 18/874,691

(22) PCT Filed: Jun. 14, 2023
(86) PCT No.: PCT/CA2023/050823

§ 371 Date: Dec. 13, 2024

Related U.S. Application Data
(60) Provisional application No. 63/352,451, filed on Jun. 15, 2022.

(51) Int. Cl. B29C 45/16; B29C 45/28

(52) U.S. Cl. CPC B29C 45/1603; B29C 45/2806

(57) ABSTRACT

A co-injection molding apparatus that includes a melt receiver that is configured to receive both the first melt stream of a first molten material and a second melt stream of a second molten material from a corresponding machine nozzle at a common melt-receiving interface is disclosed. The melt receiver defines a first molten material-receiving passage for receiving the first melt stream and a second melt-receiving passage for receiving the second melt stream. The first molten material-receiving passage is defined by a central bore extending through the melt receiver. The second molten material-receiving passage includes an annular melt-receiving passage that extends into the melt receiver from the molten material-receiving interface, wherein the annular melt-receiving passage is disposed around the central bore that defines the first melt-receiving passage such that the annular melt-receiving passage is disposed outwardly away from a central axis extending through the first molten material-receiving passage.

### CROSS-REFERENCE TO RELATED APPLICATION(S)

This application claims the benefit of priority to U.S. Provisional Application No. 63/352,451 filed Jun. 15, 2022, titled “CO-INJECTION MOLDING APPARATUS”, the contents of which are hereby expressly incorporated into the present application by reference in their entirety.

### FIELD

The present disclosure relates to injection molding systems. In particular, the present disclosure relates to melt receivers and nozzles for co-injection hot runner systems for injection molding systems.

### BACKGROUND

Co-injection molding is a sequential injection molding process used for forming molded parts made from two different materials or components. With this technology, a core component or core material (e.g. encapsulated material) is injected into an outer component or “skin” component or material. Co-injection molding involves injecting two resins simultaneously, or sequentially, through a single gate to form a multi-layer molded part. In a co-injection molding process, the skin material is injected into the mold cavity first, through a single mold gate, which injection is immediately followed by the injection of the core material through the same mold gate. As the material is injected into the mold cavity through the nozzle, a flow front develops with a parabolic velocity profile that extends from the centre of the mold and outwardly to the mold wall due to viscosity differences in the injected material. As the fastest material travelling in the center of the flow reaches the flow front, the flow splits towards the outer wall and freezes against the cavity wall forming a frozen layer of material or skin layer. Prior to the skin material reaching the end of the cavity, the second material is injected into the mold cavity, through the same gate, to form the core of the molded product. As the core material is injected into the mold cavity, the core material develops a second flow front thereby pushing the first material or skin material ahead of it. In co-injection molding processes, it is important to have the correct skin-to-core ratio of materials to ensure that the skin material reaches the end of the cavity just ahead of the core material to form the outer layer of skin layer as unequal and/or uneven distribution of the two materials within the mold cavity can affect the overall quality of the molded product. Once the entire mold is filled with the melt material, additional pressure is added from the incoming material stream to start the compression stage of the molding process. As the sample is compressed, the polymer melt is packed and pressure rises within the cavity as maximum pressure is reached. Once the maximum pressure is reached, the holding pressure stage begins and solidification of the melt material takes place. As the melt material cools, the material undergoes thermal contraction which causes the pressure within the mold cavity to drop. This can sometimes lead to differential pressure and pressure spiking issues during the solidification stage.

As co-injection molding processes require the correct skin-to-core ratio of materials and also require that the skin and core materials are distributed appropriately within the mold cavity in order to achieve a molded part with the required quality, co-injection hot runner systems that provide for a more mechanically balanced system and more balanced delivery of molten material are desirable.

### BRIEF DESCRIPTION OF THE DRAWINGS

Reference will now be made, by way of example, to the accompanying drawings which show example embodiments of the present application, and in which:

FIG. 1 is a front view of a co-injection hot runner system according to an example embodiment of the present disclosure;

FIG. 2 is a cross-sectional view of the co-injection hot runner system of FIG. 1 as taken along section line A-A;

FIG. 3 is a cross-sectional view of the co-injection hot runner system of FIG. 1 as taken along section line B-B;

FIG. 4 is a front view of the co-injection hot runner system of FIG. 1 illustrating a first stage of the co-injection process;

FIG. 5 is a front view of the co-injection hot runner system of FIG. 1 illustrating a second stage of the co-injection process;

FIG. 6 is a front view of the co-injection hot runner system of FIG. 1 illustrating a third stage of the co-injection process;

FIG. 7 is a perspective view illustrating the flow paths through the co-injection hot runner system of FIG. 1 with the components of the hot runner system removed for ease of illustration;

FIG. 8 is a perspective view illustrating the flow path of the second material through the co-injection hot runner system of FIG. 1 with the components of the hot runner system removed for ease of illustration;

FIG. 9 is a perspective view illustrating the flow path of the first material through the co-injection hot runner system of FIG. 1 with the components of the hot runner system removed for ease of illustration;

Similar reference numerals may have been used in different figures to denote similar components.

### DESCRIPTION OF EXAMPLE EMBODIMENTS

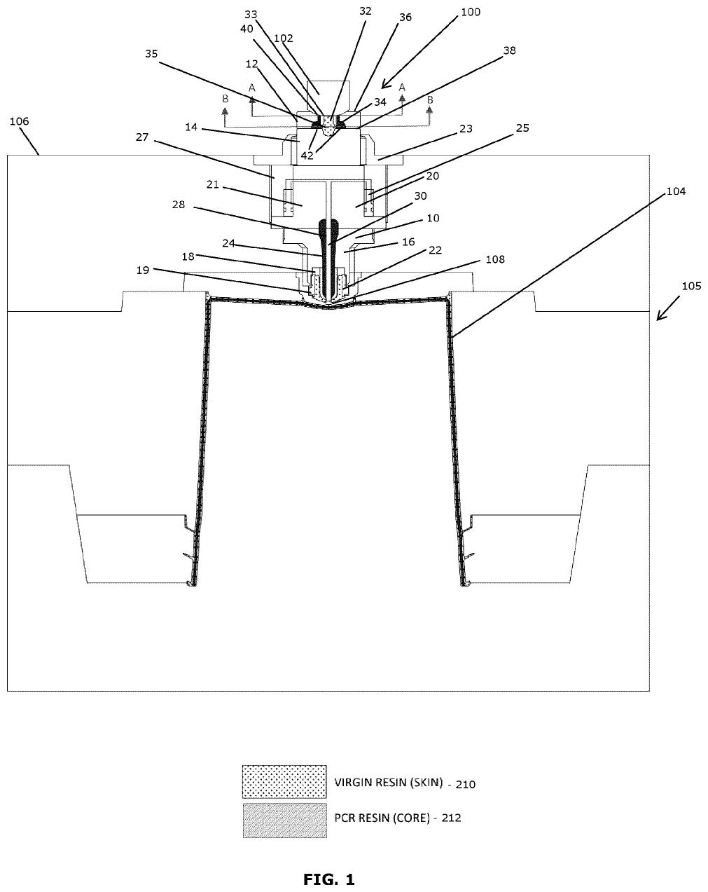

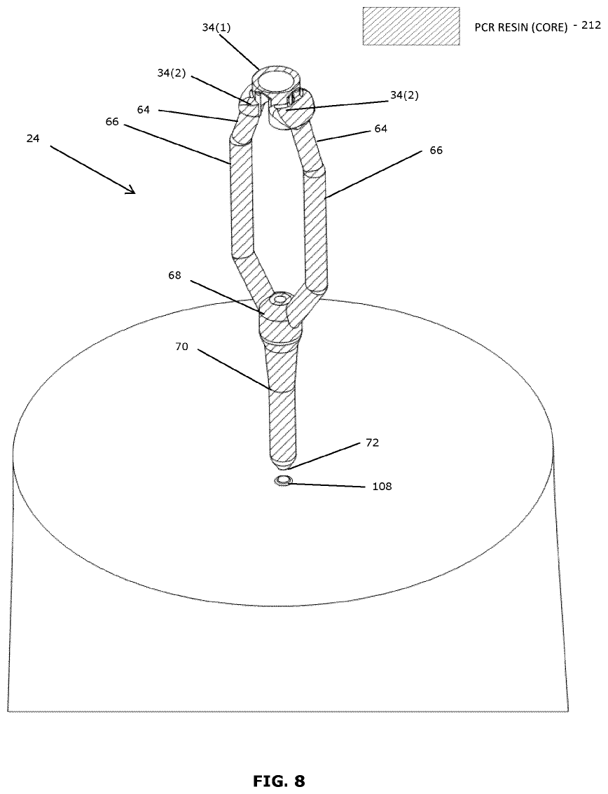

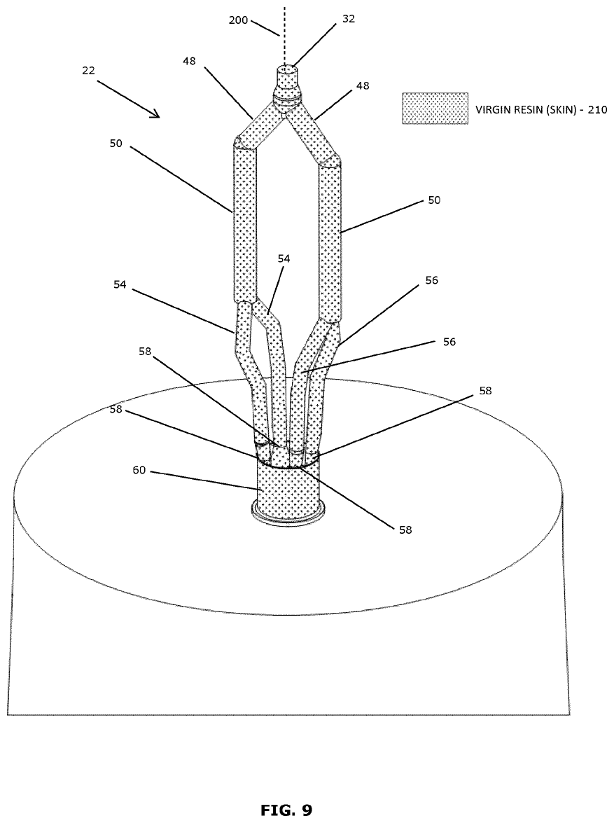

Referring now to FIGS. 1-9 there is shown an example embodiment of a co-injection molding apparatus 100 according to an example embodiment of the present disclosure. The co-injection molding apparatus 100 is configured for receiving predetermined amounts of a first molten material (or a first melt material) 210 and a second molten material (or second melt material) 212 from a machine nozzle 102, and for delivering the received first and second molten materials 210, 212 to a cavity 104 of a corresponding mold 105 of the overall system. In some embodiments, for example, the first molten material 210 is a skin material, for forming the outer layer or “skin” layer of the molded product while the second molten material 212 is a core material. In the injection sequence, the first molten material 210 is injected into the system via the co-injection molding apparatus 100 forming the skin or outer layer, which is followed by an injection of the second or core material 212. The injection of the second molten material or core material 212 is followed by a further injection of the first molten material (or skin material) 210 such that the second molten material 212 is encapsulated within the skin material or first molten material 210, the second molten material 212 thereby forming the core of the molded product. In the co-injection hot runner system 100, the first molten material 210 and the second molten material 212 are each delivered to the same cavity 104 via system nozzle 10 through a single mold gate 108.

With reference, in particular to FIG. 1, the co-injection molding apparatus 100 includes a melt receiver 12 that is mounted on the molten-material receiving side of a manifold plate 106 of the overall system. The melt receiver 12 is configured to receive both the predetermined amount of the first molten material (or skin material) 210 and the predetermined amount of the second molten material 212 from the corresponding machine nozzle 102. In this respect, the melt receiver 12 defines a molten material-receiving interface 13 that is configured for cooperating with the machine nozzle 102. The melt receiver 12 is mounted in communication with a melt transfer bushing 14. The melt transfer bushing 14 is configured for transferring the molten material received at the melt receiver 12, from the machine nozzle 102, to the system nozzle 10 for injection into the corresponding mold cavity 104, via a valve mechanism 20. The valve mechanism 20 is operably coupled to and is disposed in communication with the system nozzle 10 for controlling the delivery of the first molten material 210 and the second molten material 212 to the mold cavity 104. The valve mechanism 20 receives both the first molten material 210 and the second molten material 212 from the melt transfer bushing 14 and is configured for controlling the flow of the first molten material 210 and the second molten material 212 through the nozzle 10 to the mold cavity 104.

The system nozzle 10 operates in conjunction with the valve mechanism 20 and is configured for receiving the predetermined amounts of the first molten material 210 and the second molten material 212, and for delivering and/or injecting the predetermined amounts of the first molten material and the second molten material into the mold cavity 104 through the mold gate 108. In some embodiments, for example, the system nozzle 10 includes a nozzle body 16 and nozzle tip 18 that is coupled to the nozzle body 16 via a nozzle lock nut 19.

In some embodiments, for example, the valve mechanism 20 includes a valve body 21 that is disposed intermediate the melt transfer bushing 14 such that the system nozzle 10 receives molten material at an upstream end of the nozzle body 16 via valve body 21. Accordingly, in some embodiments, for example, the melt receiver 12, the melt transfer bushing 14, the valve mechanism 20 and the system nozzle 10 are disposed in series and mounted, in alignment, within the manifold plate 106 by any suitable means and/or in accordance with principles known in the art. In some embodiments for example, the melt receiver 12 is mounted to the melt transfer bushing 14, which in turn, is mounted and located relative to the manifold plate 106 by means of a locator ring 23, while the valve mechanism 20 is located within the manifold plate 106 by a surrounding cylinder 25 and cylinder body 27.

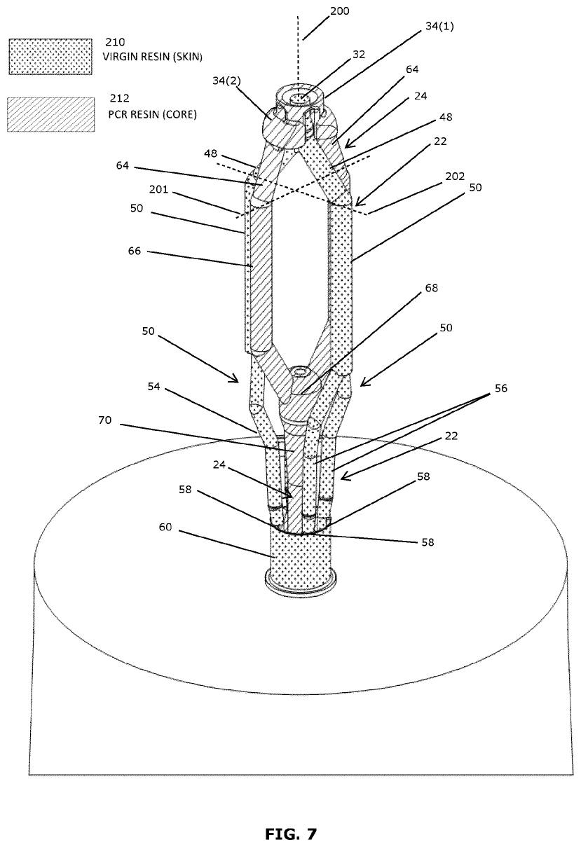

With reference now to FIG. 7, the co-injection molding apparatus 100 is configured for delivering two separate streams of molten material to a mold cavity 104. In this respect, the apparatus 100 defines a first melt channel 22 that is configured for receiving a first melt stream of the first molten material 210 and delivering the first melt stream to the cavity 104 via the nozzle 10. The co-injection apparatus 100 further includes a second melt channel 24 that is configured for receiving the second melt stream of the second molten material 212 and delivering the second melt stream to the cavity via the nozzle 10. The first melt channel 22 and the second melt channel 24 are each, independently, configured for fluid communication with the mold gate 108 such that both the first melt stream and the second melt stream are discharged from the nozzle 10 into the mold cavity 104 through the same mold gate 108.

Valve mechanism 20 controls the injection of the first melt stream and the second melt stream to the mold cavity 104. In this respect, the valve mechanism 20 is operably coupled to the nozzle 10 and is configured for selectively establishing fluid communication between one of the first melt channel 22 and the second melt channel 24, and the mold cavity 104, through mold gate 108. In some embodiments, for example, the nozzle body 16 includes a central passage 28 that is configured for receiving and cooperating with a valve pin 30 that forms part of the valve mechanism 20 and is operably coupled to the nozzle 10. The valve pin 30 is configured to reciprocate and/or slide within the central passage 28 defined by the nozzle body 16 to control the flow of molten material from the nozzle 10 to the mold gate 108.

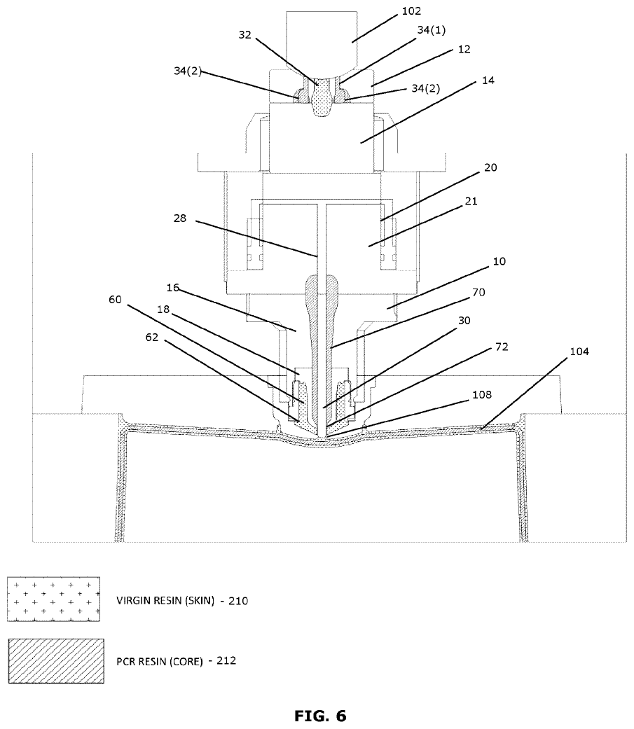

When the valve mechanism 20 is in a closed position, for example as illustrated in FIG. 6, the valve pin 30 is in a fully extended position, relative to the nozzle 10, such that the valve pin 30 extends through the nozzle 10 blocking the mold gate 108 thereby preventing fluid communication between both the melt channel 22 and the second melt channel 24 and the mold gate 108. The blocking of the mold gate 108 by the valve pin 30, while the valve mechanism 20 is disposed in the closed position, is effective for preventing molten material from being discharged from the nozzle 10 and entering the mold cavity 104.

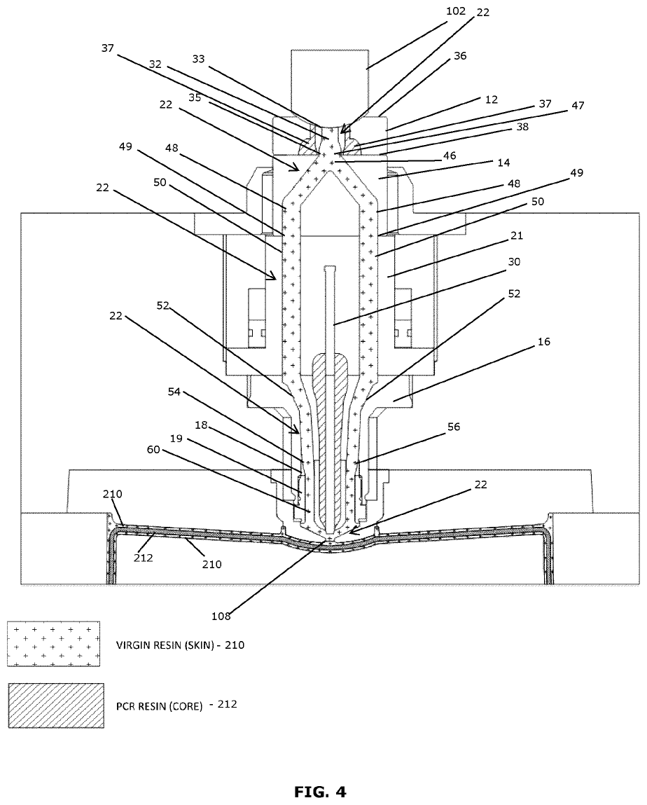

When the valve mechanism 20 is disposed in a first open position (see, for example, FIG. 4), the valve pin 30 is positioned relative to the nozzle 10 in a first retracted position relative to the nozzle 10 such that the first melt channel 22 is in fluid communication with the mold gate 108, the positioning of the valve pin 30 thereby allowing the first melt stream to be discharged from the nozzle 10 into the mold cavity 104 through the mold gate 108. While the valve mechanism 20 is in the first open position, the positioning of the valve pin 30, relative to the nozzle 10, is such that the second melt channel 24 remains blocked by the valve pin 30 thereby preventing fluid communication between the second melt channel 24 and the mold gate 108. Accordingly, there is an absence of fluid communication between the second melt channel 24 and the mold gate 108, while the valve mechanism 20 is disposed in the first open position.

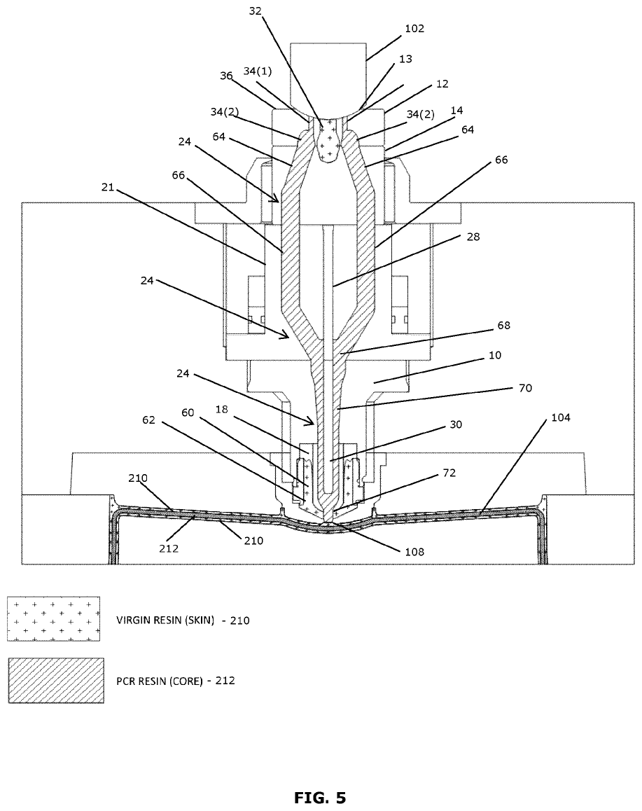

When the valve mechanism 20 is in the second open position (see, for example, FIG. 5), the valve pin 30 is disposed in a second, retracted position, relative to the nozzle 10, wherein the valve pin 30 positioned within the central passage 28 of the nozzle body 16 such that the second melt channel 24 is disposed in fluid communication with the mold gate 108 thereby allowing the second melt stream of the second molten material 212 to be discharged from the nozzle 10 and into the mold cavity 104 through the mold gate 108 behind the first melt stream of the first molten material 210. Accordingly, while the valve mechanism 20 is in the second open position such that the valve pin 30 is disposed in the second retracted position, both the first melt channel 22 and the second melt channel 24 are in fluid communication with the mold gate 108. This allows for the simultaneous and/or sequential injection of both the first molten material and the second molten material into the mold cavity 104 for creating the multi-component product.

In order to fully encapsulate the second molten material with the first molten material, once the injection of the second molten material into the mold cavity 104 is complete, the valve mechanism 20 is returned to the first open position. Returning of the valve mechanism 20 to the first open position such that the valve pin 30 returns to the first retracted position is with effect that the valve pin 30 blocks the outlet of the second melt channel 24 thereby preventing fluid communication between the second melt channel 24 and the mold gate 108. While the valve pin 30 is disposed in the first retracted position, fluid communication between the first molten material delivery passage 22 and the mold gate 108 remains effective thereby allowing the first molten material 210 to be delivered to the mold cavity 104 behind the previously injected second molten material. The second injection of the first molten material 210 into the mold cavity 104, after the injection of the second molten material 212, also ensures that all of the previously injected second molten material 212 is pushed through the mold gate 108 and cleared from the nozzle outlet. This prevents any residual second molten material 212 from being injected into the mold cavity 104 along with the first molten material 210 in the next injection process (or cycle) which would contaminate the outer or skin layer of the next molded product.

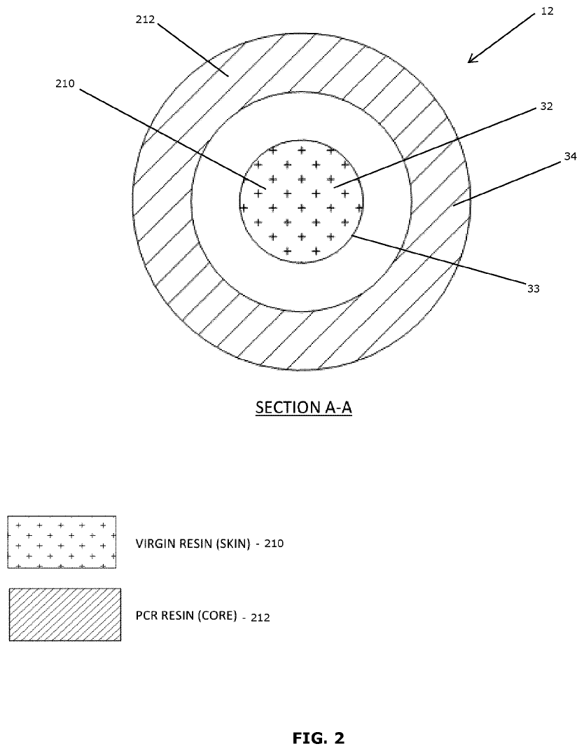

With reference now to FIGS. 2-9, the melt receiver 12 and the manner in which the first melt channel 22 and the second melt channel 24 extend through the co-injection molding apparatus 100 are described in further detail.

As set out above, the co-injection molding apparatus 100 according to the present disclosure, includes a melt receiver 12 that is configured to receive the first melt stream of the first molten material 210 and the second melt stream of the second molten material 212 from the corresponding machine nozzle 102. In this respect, the melt receiver 12 defines a first molten material-receiving passage 32 that is configured for receiving the first melt stream of the first molten material 210, the first melt-receiving passage 32 thereby defining the inlet to the first melt channel 22 defined by the apparatus 100. The melt receiver 12 further defines a second melt-receiving passage 34 that is configured for receiving the second melt stream of the second molten material 210 from the machine nozzle 102, the second melt-receiving passage 34 thereby defining the inlet to the second melt channel 24 defined by the apparatus 100.

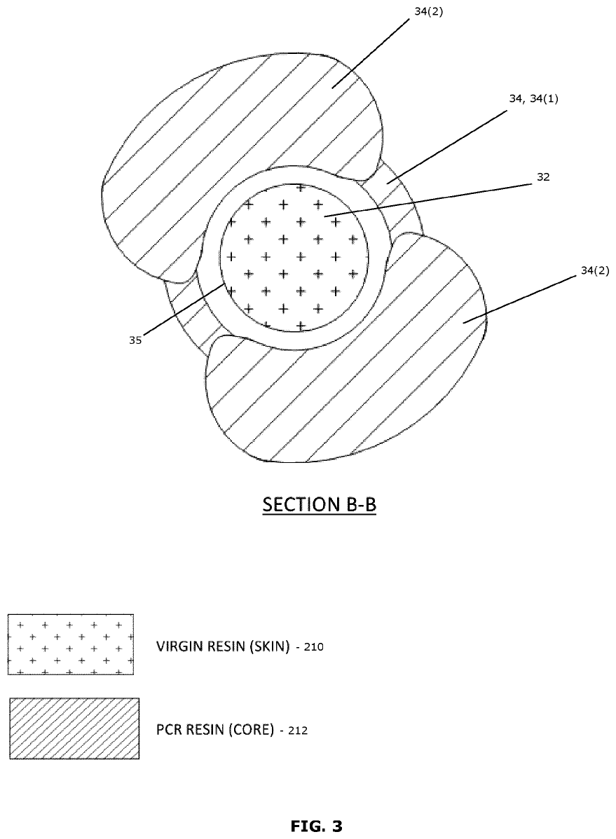

Referring now to FIGS. 2 and 3, the first melt-receiving passage 32 is a centrally arranged, or substantially centrally arranged, passage that extends through the melt receiver 12 from an inlet end 33 defined by the molten material receiving interface 13, on a first side 36 of the melt receiver 12, to a first melt receiver outlet 35 disposed on a second, opposite side 38 of the melt receiver 12. In some embodiments, for example, the first molten material-receiving passage 32 is defined by a central bore that extends through the melt receiver 12, such that the inlet end 33 of the first molten material-receiving passage 32 and the first melt receiver outlet 35 are each, independently, defined by a circular opening. In some embodiments, for example, the circular opening that defines the first melt receiver outlet 35 is larger in diameter than the circular opening that defines the inlet end 33 of the first molten material-receiving passage 32 such that the diameter of the first molten material-receiving passage 32 expands as the first molten material-receiving passage 32 extends through the melt receiver 12 as is shown, for example, in the cross-sectional views of the apparatus 100 illustrated in FIGS. 4-6.

The second melt-receiving passage 34 defined by the melt receiver 12 includes an annular melt-receiving passage 34(1) that extends into the melt receiver 12 from the molten material-receiving interface 13 defined by the melt receiver 12. The annular melt-receiving passage 34(1) is configured such that it is disposed around the first melt-receiving passage 32 such that the annular melt-receiving passage 34(1) is spaced radially outwardly relative to the generally centrally arranged first melt-receiving passage 32, as illustrated for example in FIG. 2. The second melt-receiving passage 34, therefore, extends from an inlet end 40 that is disposed on the molten material-receiving interface 13 of the melt receiver 12 into the body of the melt receiver 12 before splitting into two, independent second melt receiver outlet passages 34(2), as is illustrated, for example, in FIG. 3. The two, independent second melt receiver outlet passages 34(2) each, independently, extend through the melt receiver 12 such that the second melt stream is discharged from the melt receiver 12 in two, independent second molten material streams, each of the second molten material streams, independently, being discharged via a respective one of the pair of second melt receiver outlet passages 34(2). Accordingly, the co-injection molding apparatus 100 includes a first melt channel 22 and a second melt channel 24, wherein the first melt channel 22 includes a first molten material inlet 33 defined by a central bore that extends through a melt receiver body 12, and the second melt channel 24 includes a second molten material inlet 34 defined by an annular melt-receiving passage 34(1) that is disposed around and is spaced apart from the first molten material inlet 33, the first molten material inlet 33 and the annular melt-receiving passage 34(1) disposed on a melt-receiving interface defined by the melt receiver 12 that is configured for cooperating with the machine nozzle 102 for receiving the first melt stream and the second melt stream.

Referring now to FIGS. 4, 7 and 9, the configuration of the first melt channel 22 and the manner in which the first melt channel 22 through the melt receiver 12, the melt transfer bushing 14 and the valve mechanism 20 to the nozzle 10 will now be described in further detail.

With reference, in particular, to FIG. 4, the melt receiver 12 is mounted on the melt transfer bushing 14, the melt transfer bushing 14 being fluidly coupled to the nozzle 10 via the valve mechanism 20. Accordingly, the melt receiver 12, the melt transfer bushing 14, the valve mechanism 20 and the nozzle 10 are cooperatively configured such that the first molten material travels from the melt receiver 12, through the melt transfer bushing 14 and the valve body 21 to the nozzle 10. As shown in FIG. 4, the melt receiver 12 is mounted on the melt transfer bushing 14 such that the first melt receiver outlet 35 of the first molten material-receiving passage 32 is disposed in fluid communication with a first molten material transfer passage 46 defined by the melt transfer bushing 14. In some embodiments, for example, the first molten material transfer passage 46, includes a first molten material transfer passage inlet 47 and a pair of first molten material transfer passage outlet passages 48. In some embodiments, for example, the first molten material transfer passage inlet 47 is defined by a central opening formed in the melt transfer bushing 14 that extends into the melt transfer bushing 14 before splitting into the two, separate first molten material transfer passage outlet passages 48. Each one of the first molten material transfer passage outlet passages 48, independently, extends through the melt transfer bushing 14 from the first molten material transfer passage inlet 47 to a respective first molten material transfer passage outlet opening 49 defined on a second, opposite side of the melt transfer bushing 14.

The valve mechanism 20 is mounted intermediate the melt transfer bushing 14 and the nozzle 10, the valve mechanism 20 being operably coupled to the nozzle 10 for controlling the discharge of molten material therefrom. In some embodiments, for example, the valve mechanism 20 is configured for transferring the first melt stream and the second melt stream, independently, from the melt transfer bushing 14 to an upstream end of the nozzle 10. In this respect, in some embodiments, for example, the valve body 21 includes a pair of first molten material valve passages 50, each of the first molten material valve passages 50, independently, being fluidly coupled to a corresponding first molten material transfer passage outlet passage 48 for receiving the first melt stream from the melt transfer bushing 14. Each of the first molten material valve passages 50 extend through the valve body 21 are, independently, fluidly coupled to the first molten material delivery passage 52 defined by the nozzle 10. The first molten material delivery passage 52 includes a pair of first molten material delivery passages 52 that extend into the upstream end of the nozzle body 16 before each of the first molten material delivery passages 52, independently, split into two further sub-passages, such that the portion of the first melt channel 22 that extends through the nozzle 10 includes a first pair of first molten material delivery sub-passages 54, and a second pair of first molten material delivery sub-passages 56. In this respect, the first molten material travels through the nozzle body 16 in the four separate first molten material transfer sub-channels 54, 56 which four separate first molten material transfer sub-channels 54, 56 are configured such that they feed the first molten material to nozzle tip 18 at four separate first melt material nozzle tip entry points 58 disposed about the nozzle tip 18. The four separate first melt material transfer sub-channels 54, 56 extend through the nozzle body 16 such that they are spaced apart from each other around the nozzle body 16 at regular intervals thereby providing a balanced delivery of the first molten material to the nozzle tip 18. In some embodiments, for example, the four separate first melt material nozzle tip entry points 58 are also disposed at spaced apart intervals about the nozzle tip 18 to provide for even and balanced delivery of the first molten material through the nozzle tip 18. In some embodiments, for example, the four separate first molten material transfer sub-channels 54, 56 are spaced apart equidistantly about the nozzle body 16 while the four separate first molten material nozzle tip entry points 58 are also spaced apart equidistantly about the nozzle tip 18. The four separate first melt nozzle tip entry points 58 extend through the nozzle tip 18 and into an annular first melt-receiving space 60 that is defined between an outer surface of the nozzle tip 18 and the nozzle lock nut 19 that supports the nozzle tip 18 relative to the nozzle body 16. The annular first melt-receiving space 60 that is defined between the outer surface of the nozzle tip 18 and the nozzle lock nut 19 extends from the nozzle tip entry points 58 to a first molten material discharge outlet 62 defined at the downstream end of the nozzle 10. When the valve mechanism 20 is in one of the first or second open positions, the first molten material discharge outlet 62 is in fluid communication with the mold gate 108 thereby allowing the first molten material that is discharged from the nozzle 10 through the first molten material discharge outlet 62 to enter the mold cavity 104 through mold gate 108, the first molten material thereby entering the mold cavity 104 in a single stream via the mold gate 108. In some embodiments, the first molten material delivery outlet passage 60 is defined by an annular passage that is formed between the nozzle tip 18 and nozzle tip lock nut 19.

In use, when the first melt stream of the first molten material is received at the melt receiver 12, the first melt stream travels through the central, first melt receiving passage 32 to the melt transfer bushing 14. While travelling through the melt transfer bushing 14, the first melt stream is split into two, independent streams, each stream being discharged from the melt transfer bushing 14 through a corresponding one of the pair of first molten material transfer passage outlet passages 48. The two, independent steams of the first molten material travel through the valve body 21 in a corresponding first molten material valve passage 50 before each of the independent streams of the first molten material are further divided into respective pairs of first molten material delivery sub-passages 54, 56 in the nozzle 10. The four, separate first molten material delivery sub-passages 54, 56 feed the nozzle tip 18 at four individual first molten material nozzle tip receiving points 60 before merging together in the first molten material discharge outlet passage 62. The dividing of the first melt stream of the first molten material from an initial single stream into two independent streams of the first molten material that are then further subdivided, respectively, it to two further sub-streams for a total of four independent streams of the first molten material travelling through the nozzle body 16 before merging together such that the first molten material is discharged from the apparatus 100 and into the mold cavity 104 in a single stream has been found to provide more even pressure distribution throughout the apparatus 100 during the injection molding process which serves to prevent pressure imbalances that can have a negative effect on the overall quality of the molded product.

With reference now, in particular, to FIGS. 5, 7 and 8, the configuration of the second melt channel 24 and the manner in which the second melt channel 24 extends through the melt receiver 12, the melt transfer bushing 14 and the valve body 21 to the nozzle 10 will now be described in further detail.

From the melt receiver 12, the second melt stream of the second molten material exits the melt receiver 12 through the second melt receiver outlet passages 34(2). Each of the second melt receiver outlet passages 34(2) defined by the melt receiver 12, independently, feeds a corresponding second melt material transfer channel 64 that extends through the melt transfer bushing 14. The two separate, second melt material transfer channels 64 are each disposed in fluid communication with a corresponding second molten material valve passage 66 that extends through the valve body 21. Accordingly, the valve body includes a pair of second molten material valve passage 66 that are configured such that each one of the pair of second molten material valve passages 66, independently, is fluidly coupled to a corresponding one of the second molten material transfer passages 64 for receiving the second melt stream of the second molten material from the melt transfer bushing 14 and delivering the second melt stream to the nozzle 10. The valve body 21 is further configured such that the two, separate second molten material valve passages 66 converge towards one another and merge together at a downstream end of the valve body 21 such that the second molten material is discharged from the valve body 21 through a single, second molten material valve body outlet 68. The second molten material valve body outlet 68, in turn, feeds the second molten material delivery channel 70 that is defined by the nozzle 10. The second molten material delivery channel 70 extends generally centrally through the nozzle body 16 such that the second molten material delivery channel 70 is inwardly disposed relative the first molten material delivery sub-passages 54, 56, relative to a central axis of the nozzle 10. The second molten material delivery channel 70 extends through the nozzle body 16 and nozzle tip 18 to a second molten material discharge outlet 72 defined by the nozzle tip 18. When the valve mechanism 20 is disposed in the second open position wherein the valve pin 30 is disposed in the second retracted position, relative to the nozzle body 16, the second molten material discharge outlet 72 is in fluid communication with the mold gate 108 thereby allowing the second melt stream of the second molten material 212 to be discharged from the nozzle 10 and into the mold cavity 104 through the mold gate 108.

As with the first molten material, the discharge of the second molten material into the mold cavity 104 is controlled by the valve mechanism 20. When the valve mechanism is in the closed position, as is illustrated for example in FIG. 6, the valve pin 30 is in a fully extended position, relative to both the valve body 21 and the nozzle body 16, such that the end of the valve pin 30 extends through the nozzle tip 18 and through the mold gate 108 that feeds the mold cavity 104. While the valve pin 30 is disposed in the fully extended position, the valve pin 30 effectively closes or blocks the second molten material discharge outlet 72, due to the extension of the valve pin 30 through the nozzle tip 18, and also effectively blocks and/or prevents fluid communication between the first molten material discharge outlet 62 and the mold cavity 104 via the mold gate 108, due to the extension of the valve pin 30 into the gate 108.

When the valve mechanism 20 is in the first open position, as is illustrated, for example, in FIG. 4, the valve pin 30 is in a first retracted position wherein the valve pin 30 is positioned relative to the nozzle body 16 and nozzle tip 18 such that the annular first molten material outlet passage 60 of the first melt channel 22, that is defined between the outer surface of the nozzle tip 18 and an inner surface of the nozzle tip lock nut 19, is in fluid communication with the mold gate 108 while the second molten material discharge outlet 72 remains blocked by the valve pin 30 such that there is an absence of fluid communication between the second molten material delivery passage 70 of the second melt channel 24 that is defined through the nozzle 10 and the mold gate 108. Therefore, while the valve mechanism 20 is in the first open position, only the first melt channel 22 is in fluid communication with the mold gate 108.

When the valve mechanism 20 is in the second open position, as is illustrated, for example, in FIG. 5, the valve pin 30 is in a second retracted position wherein the valve pin 30 is positioned relative to the nozzle body 16 and nozzle tip 18 such that fluid communication is established between the second molten material delivery passage 70 of the second melt channel 24, as defined by the nozzle body 16 and nozzle tip 18, and the mold gate 108 thereby allowing the second melt stream of the second molten material 212 to be discharged from the nozzle 10 and into the mold cavity 104 through the mold gate 108.

In use, when an injection cycle using the disclosed co-injection molding apparatus 100 is ready to begin, the valve mechanism 20 is actuated such that the valve mechanism transitions from the closed position, wherein there is an absence of fluid communication between both the first melt channel 22 and the second melt channel 24 and the mold gate 108, to the first open position wherein the valve pin 30 is positioned, relative to the nozzle body 16 and nozzle tip, in the first retracted position. While the valve pin 30 is disposed in the first retracted position associated with the first open position of the valve mechanism 20, fluid communication between the first melt channel 22 and the mold gate 108 is established while there is an absence of fluid communication between the second melt channel 24 and the mold gate 108. Once the valve mechanism 20 is in the first open position, injection of the first molten material 210 into the mold cavity 104 can begin wherein the first molten material 210 that is received at the melt receiver 12 travels through the first melt channel 22 defined by the apparatus 100 to the mold cavity 104 via the mold gate 108 forming the skin or outer layer of the molded product. Once a predetermined amount of first molten material 210 has been injected into the mold cavity 104, the flow of the first molten material 210 can be stopped or decreased to the point that the flow of the first molten material 210 is minimal. At this point, the valve mechanism 20 is actuated such that the valve mechanism 20 transitions from the first open position to the second open position wherein the valve pin 30 is further retracted, relative to the nozzle 10 from the first retracted position to the second retracted position. Disposition of the valve pin 30 in the second retracted position establishes fluid communication between the second melt channel 24 and the mold gate 108 thereby allowing a predetermined amount of second molten material 212 to be injected into the mold cavity 104 via the nozzle 10 behind the first molten material 210. Injection of the second molten material 212 into the mold cavity 104 after the initial injection of the first molten material 210 s with effect that the second molten material 212 forms the core of the molded product. After the injection of the predetermined amount of the second molten material 212 into the mold cavity 104, the valve mechanism 20 is further actuated such that the valve mechanism 20 transitions from the second open position back to the first open position with the valve pin 30 returning to the first retracted position. Disposition of the valve pin 30 in the first retracted position blocks fluid communication between the second melt channel 24 and the mold gate 108. Once the valve mechanism 20 is returned to the first open position, a second predetermined amount of the first molten material is injected into the apparatus 100 at the melt receiver 12, the second predetermined amount of the first molten material 210 travelling through the first melt channel 22 and into the mold cavity 104 through the open mold gate 108. The injection of the second predetermined amount of the first molten material 210 serves to fully encapsulate the second molten material to produce the finished multi-component molded product. The injection of the second predetermined amount of the first molten material 210 also serves to remove any residual second molten material 212, or core material, from the mold gate 108 or area surrounding the nozzle tip 18 thereby ensuring that no second molten material 212 is injected along with the first molten material 210 in the first injection of the first molten material (or skin material) 210 in the subsequent injection cycle for the next molded product. Once the injection of the second predetermined amount of the first molten material 210 is complete, the valve mechanism 20 is returned to the closed position, as shown for example in FIG. 6, and the system 100 is readied for the next injection cycle.

By providing a melt receiver 12 that includes two separate melt receiving inlets, for receiving the two separate streams of molten materials, defined on the same molten material-receiving interface 13, for feeding the respective system defined first melt channel 22 and second melt channel 24, each stream of molten material is received at the same interface with the machine nozzle 102, with a central passage and a surrounding annular passage, allowing for a more balanced delivery of molten material to the apparatus 100. Additionally, by providing two separate melt receiving passages at the melt receiver 12, the first melt channel 22 and the second melt channel 24 each, independently, define their own flow path through the system 100. In this respect, both the first melt channel 22 and the second melt channel 24 are configured to provide more balanced delivery of molten material to the nozzle 10 and the mold gate 108. As described above, the first melt channel 22 is defined by the first melt-receiving passage 32 that extends through the melt receiver 12 and into the melt transfer bushing 14 before splitting into two separate first molten material transfer passage outlet passages 48. These two separate first molten material transfer passage outlet passages 48 feed into the first molten material valve passages 50 that extend through the valve body 21 to the nozzle 10. Accordingly, from the melt receiver 12, the first melt stream of the first molten material 210 travels through the apparatus 100 to the nozzle 10 in two separate melt streams that are arranged relative to one another such that the two separate melt streams of the first molten material are arranged opposite to one another across a first plane 201 that is disposed parallel to and extends through a central axis 200 of the apparatus 100, the two separate melt streams of the first molten material 210 being aligned with one another along a second plane 202 that extends perpendicular to the first plane 201. The second melt channel 24 is defined by the annular melt-receiving passage 34(1) and the two separate second melt-receiver outlet passages 34(2) that extend through the melt receiver 12 and into the melt transfer bushing 14. Accordingly, the second melt stream of the second molten material travels through the melt transfer bushing 14 and the valve body 21 in two separate streams through the second molten material transfer passages 64 and the second molten material valve passages 66. These two separate streams of the second molten material 212 merge together in the downstream end of the valve body 21, the second molten material therefore being discharged from the valve body 21 and into the nozzle 10 in a single second molten material stream. The merged second molten material stream travels through the nozzle 10 via the second molten material delivery passage 70, which extends through the central passage 28 of the nozzle body 16 surrounding the valve pin 30, and is discharged from the nozzle 10 through the second molten material discharge outlet 72. The second molten material transfer passages 64 and the second molten material valve passages 66 that carry the two separate streams of the second molten material are cooperatively configured, with the first molten material transfer passage outlet passages 48 and the first molten material valve passages, such that the two separate streams of the second molten material 212 are disposed opposite to one another across the second plane 202, along which the two separate streams of first molten material 210 are aligned, the two separate streams of the second molten material being aligned along the first plane 201. Additionally, the first pair of first molten material delivery sub-passages 54 are configured such that the first molten material delivery sub-passages 54 are disposed on opposite sides of the second plane 201. The configuration of the first melt channel 22 and the second melt channel 24 through the apparatus 100 with the branching of the two different molten material streams provides for a more balanced delivery of molten material to the mold gate 108. By providing a more mechanically balanced overall system, the delivery of the molten material to the mold cavity 104 is also more balanced and evenly distributed within the mold which, in turn, contributes to the overall quality of the finished molded product.

While an example embodiment of the co-injection injection molding apparatus has been described, it will be understood that certain adaptations and modifications to the described embodiments can be made. Therefore, the above discussed embodiments are considered to be illustrative and not restrictive.

1. A co-injection molding apparatus comprising:
a melt receiver defining:
a first molten material-receiving passage configured for receiving a first melt stream of a first molten material from a machine nozzle; and
a second melt-receiving passage configured for receiving a second melt stream of a second molten material from the machine nozzle;
a nozzle fluidly coupled to the melt receiver, the nozzle defining:
a first molten material delivery passage configured for delivering the first melt stream received at the melt receiver to a mold cavity; and
a second molten material delivery passage for delivering the second melt stream received at the melt receiver to the mold cavity;
a valve mechanism operably coupled to the nozzle and configured for selectively establishing fluid communication between one of the first molten material delivery passage and the second molten material delivery passage, and the mold cavity, via a mold gate; and
wherein:
the melt receiver defines a molten material-receiving interface configured for cooperating with the machine nozzle;
the first molten material-receiving passage is defined by a central bore extending through the melt receiver from the molten material-receiving interface to a first melt receiver outlet; and
the second molten material-receiving passage includes an annular melt-receiving passage that extends into the melt receiver from the molten material-receiving interface, wherein the annular melt-receiving passage is disposed around the central bore that defines the first melt-receiving passage such that the annular melt-receiving passage is disposed outwardly away from a central axis extending through the first molten material-receiving passage.

2. The co-injection molding apparatus as claimed in claim 1;
wherein:
the melt receiver defines a pair of second melt receiver outlet passages; and
the annular melt-receiving passage is fluidly coupled to each of the second melt receiver outlet passages such that the second melt stream is discharged from the melt receiver in two, independent second molten material streams, each of the second molten material streams, independently, being discharged via a respective one of the pair of second melt receiver outlet passages.

3. The co-injection molding apparatus as claimed in claim 2, wherein:
the annular melt-receiving passage and each of the second melt receiver outlet passages are cooperatively configured such that the two, independent second molten material streams that are discharged from the melt receiver via the pair of second melt receiver outlet passages, are two, equal second melt material streams.

4. The co-injection molding apparatus as claimed in claim 3;
wherein:
the pair of second melt receiver outlet passages is configured such that a first one of the pair of second melt receiver outlet passages is disposed opposite to a second one of the pair of second melt receiver outlet passages across a first plane that is disposed parallel to and extends through a central axis of the melt receiver, the first one and the second one of the pair of second melt receiver outlet passages being aligned along a second plane that extends perpendicular to the first plane.

5. The co-injection molding apparatus as claimed in claim 4;
further comprising:
a melt transfer bushing configured for receiving the first melt stream and the second melt stream from the melt receiver and transferring the first melt steam and the second melt stream to the nozzle, the melt transfer bushing defining:
a first molten material transfer passage; and
a second molten material transfer passage, the second molten material transfer passage including a pair of second molten material transfer passages;
wherein:
the melt receiver and the melt transfer bushing are cooperatively configured such that:
the first melt receiver outlet is disposed in fluid communication with the first molten material transfer passage for receiving the first melt stream from the melt receiver; and
each one of the second melt receiver outlet passages is, independently, disposed in fluid communication with a corresponding one of the pair of second molten material transfer passages for receiving the second melt stream from the melt receiver;
the first molten material transfer passage comprising:
a first molten material transfer passage inlet; and
a pair of first molten material transfer passage outlet passages, each one of the pair of first molten material transfer passage outlet passages extending between the first molten material transfer passage inlet defined on a first side of the melt transfer bushing to a respective first molten material transfer passage outlet defined on a second, opposite side of the melt transfer bushing.

6. The co-injection molding apparatus as claimed in claim 5;
wherein:
the pair of first molten material transfer outlet passages is configured relative to the pair of second molten material transfer passages such that a first one of the pair of first molten material transfer passages is disposed opposite to a second one of the pair of first molten material transfer passages across the second plane, the first one and the second one of the pair of first molten material transfer passages being aligned along the first plane.

7. The co-injection molding apparatus as claimed in claim 6;
wherein:
the valve mechanism includes a valve body and a valve pin;
the valve mechanism is mounted intermediate the melt transfer bushing and the nozzle such that the first melt stream and the second melt stream are each, independently, transferred to the nozzle from the melt transfer bushing via the valve body;
the valve pin is operably coupled to the valve body and extends between the valve body and the nozzle, the valve pin configured to reciprocate relative to the valve body and the nozzle for selectively controlling the discharge of either the first melt stream from the first molten material delivery passage, or the second melt stream from the second molten material delivery passage.

8. The co-injection molding apparatus as claimed in claim 7;
wherein:
the valve body includes:
a pair of first molten material valve passages, each of the first molten material valve passages, independently, being fluidly coupled to a corresponding one of the pair of first molten material transfer passages for receiving the first melt stream from the melt transfer bushing and delivering the first melt stream to the nozzle, each one of the first molten material valve passages, independently, extending through the valve body to a respective first molten material valve outlet; and
a pair of second molten material valve passages, each of the second molten material valve passages, independently, being fluidly coupled to a corresponding one of the second molten material transfer channels for receiving the second molten material from the melt transfer bushing and delivering the second melt stream to the nozzle, wherein the pair of second material valve passages merge together within the valve body such that the second melt stream is delivered to the second molten material delivery passage from the valve body in a single second melt stream that is discharged from the valve body via a second molten material valve outlet.

9. The co-injection molding apparatus as claimed in claim 8;
wherein:
the first molten material delivery passage includes:
a first pair of first molten material delivery sub-passages; and
a second pair of first molten material delivery sub-passages;
the first pair of molten material delivery sub-passages receiving the first melt stream of the first molten material from a first one of the pair of first molten material valve passages;
the second pair of molten material delivery sub-passages receiving the first melt stream of the first molten material from a second one of the pair of first molten material valve passages.

10. The co-injection molding apparatus as claimed in claim 9;
wherein
the first pair of first molten material delivery sub-passages and the second pair of first molten material delivery sub-passages are cooperatively configured such that each first molten material delivery sub-passage independently, extends through the nozzle and adjacent ones of the first molten material delivery sub-passages are disposed at spaced apart intervals about the nozzle body.

11. The co-injection molding apparatus as claimed in claim 10
wherein:
the first pair of first molten material delivery sub-passages and the corresponding one of the first molten material valve passages are cooperatively configured such that the first melt stream travelling through the corresponding one of the first molten material valve passages is divided into two equal sub-streams, each sub-stream travelling through a corresponding one of the first pair of first molten material delivery sub-passages; and
the second pair of first molten material delivery sub-passages and the corresponding one of the first molten material valve passages are cooperatively configured such that the first melt stream travelling through the corresponding one of the first molten material valve passages is divided into two equal first melt material sub-streams, each first melt material sub-stream travelling through a corresponding one of the second pair of first molten material delivery sub-passages.

12. The co-injection molding apparatus as claimed in claim 11;
wherein:
the nozzle includes a nozzle body and a nozzle tip coupled to the nozzle body; and
the first pair of first molten material delivery sub-passages and the second pair of first molten material delivery sub-passages are cooperatively configured such that the first pair of first molten material delivery sub-passages and the second pair of first molten material delivery sub-passages are disposed at spaced apart intervals about the nozzle body, each one of the first pair of first molten material delivery sub-passages and each one of the second pair of first molten material delivery sub-passages extending through the nozzle body to the nozzle tip such that the first melt stream is received at the nozzle tip at four individual nozzle tip first molten material receivers.

13. The co-injection molding apparatus as claimed in claim 12;
wherein:
the four individual nozzle tip first molten material receivers are disposed at spaced apart intervals about the nozzle tip such that the four individual nozzle tip first molten material receivers are evenly spaced about the nozzle tip.

14. The co-injection molding apparatus as claimed in claim 12;
wherein:
the nozzle tip is coupled to the nozzle body by a nozzle tip lock nut;
the nozzle tip and the nozzle tip lock nut are cooperatively configured such that:
a first molten material discharge outlet passage is defined between an outer surface of the nozzle tip and the lock nut, the first molten material discharge outlet passage being fluidly coupled to each one of the first molten material delivery sub-passages, via the four nozzle tip first molten material receivers.

15. The co-injection molding apparatus as claimed in claim 14;
wherein:
the first molten material delivery outlet passage is defined by an annular passage.

16. The co-injection molding apparatus as claimed in claim 12;
wherein:
the nozzle body and the nozzle tip, together defining a central valve pin passage extending through the nozzle that is configured for receiving the valve pin, the valve pin configured to reciprocate relative to the nozzle within the central valve pin passage; and
the second molten material delivery passage is an annular passage that extends through the nozzle body and the nozzle tip, the second molten material delivery passage disposed about the central passage and defining a second molten material discharge outlet.

17. The co-injection molding apparatus as claimed in claim 16;
wherein:
while the valve mechanism is disposed in a closed position, the valve pin is disposed in an extended position, relative to the nozzle, such that:
there is an absence of fluid communication between the first molten material discharge outlet passage and the mold gate with effect that there is an absence of fluid communication between the first molten material delivery passage and the mold cavity; and
there is an absence of fluid communication between the second molten material discharge outlet and the mold gate with effect that there is an absence of fluid communication between the second molten material delivery passage and the mold cavity.

18. The co-injection molding apparatus as claimed in claim 17;
wherein:
while the valve mechanism is disposed in a first open position, and, the valve pin is disposed in a first retracted position, relative to the nozzle, such that:
fluid communication between the first molten material discharge outlet passage and the mold gate is established with effect that the first molten material delivery passage is fluidly coupled to the mold cavity, via the mold gate; and
there is an absence of fluid communication between the second molten material discharge outlet and the mold gate with effect that there is an absence of fluid communication between the second molten material delivery passage and the mold cavity.

19. The co-injection molding apparatus as claimed in claim 18;
wherein:
while the valve mechanism is disposed in a second open position, the valve pin is disposed in a second, retracted position, relative to the nozzle, such that:
fluid communication between the second molten material discharge outlet and the mold gate is established with effect that the second molten material delivery passage is fluidly coupled to the mold cavity, via the mold gate; and
fluid communication between the first molten material discharge outlet passage and the mold gate is maintained such that the first molten material delivery passage remains fluidly coupled to the mold cavity, via the mold gate.
